(19) United States
(12) Patent Application Publication
(10) Pub. No.: US 2014/0335346 A1
(43) Pub. Date: Nov. 13, 2014

(54) OPTICAL MEMBER, IMAGE PICKUP APPARATUS, AND METHOD FOR MANUFACTURING OPTICAL MEMBER

(71) Applicant: CANON KABUSHIKI KAISHA, Tokyo (JP)

(72) Inventors: Akira Sugiyama, Yokohama-shi (JP); Zuyi Zhang, Yokohama-shi (JP); Yoshinori Kotani, Yokohama-shi (JP); Akiko Takei, Fujisawa-shi (JP); Kenji Takashima, Tokyo (JP); Naoyuki Koketsu, Tokyo (JP)

(21) Appl. No.: 14/365,020

(22) PCT Filed: Nov. 8, 2012
(86) PCT No.: PCT/JP2012/007173

§ 371 Date: Jun. 12, 2014

(30) Foreign Application Priority Data
Dec. 15, 2011 (JP) 2011-275103

(51) Int. Cl. C03C 17/04; C03C 23/00; G02B 1/11; C03C 15/00

(52) U.S. Cl. CPC C03C 17/04; C03C 15/00; C03C 23/007; G02B 1/11; C03C 2217/734
USPC 428/312.6; 65/31; 65/17.6

(57) ABSTRACT

To provide an optical member having a porous glass layer on a substrate and rarely causing ripples.

The optical member has a porous glass layer on a substrate. The porous glass layer includes a first porous glass layer and a second porous glass layer in this order on the substrate. The first porous glass layer has a uniform porosity. The second porous glass layer has a higher uniform porosity than the first porous glass layer.

### TECHNICAL FIELD

The present invention relates to an optical member having a porous glass layer on a substrate and an image pickup apparatus having the optical member. The present invention also relates to a method for manufacturing the optical member and a method for manufacturing an image pickup apparatus having the optical member.

### BACKGROUND ART

In recent years, porous glasses have been expected to be utilized in industrial applications, such as adsorbents, microcarriers, separator membranes, and optical materials. In particular, because of their low refractive indexes, porous glasses can be widely used as optical members.

Porous glasses can be relatively easily manufactured by a process utilizing phase separation. The base material of porous glasses manufactured by utilizing phase separation is generally borosilicate glass. The raw materials of borosilicate glass include silicon oxide, boron trioxide, and alkali metal oxides. Shaped borosilicate glass is heat-treated at a constant temperature to induce phase separation (hereinafter referred to as phase separation treatment). A soluble non-silicon-oxide-rich phase is etched with an acid solution. The skeleton of porous glass thus manufactured is mainly composed of silicon oxide. The skeleton size, the pore size, and the porosity of porous glass affect the light reflectance and refractive index of the porous glass.

NPL 1 relates to simple porous glass and discloses that a non-silicon-oxide-rich phase is insufficiently etched so as to control the porosity and increase the refractive index from the surface to the interior. Furthermore, reflection from the surface of porous glass is decreased.

PTL 1 discloses a method for forming a porous glass layer on a substrate. More specifically, a film containing borosilicate glass (phase-separable glass) is formed on a substrate by printing, and is heat-treated for phase separation and is etched to form a porous glass layer on the substrate.

In the case of a porous glass layer having a thickness of several micrometers on a substrate as described in PTL 1, light reflected from the top surface of porous glass interferes with light reflected from the interface between the substrate and the porous glass and may cause ripples (interference fringes).

However, light reflected from the interface between the substrate and the porous glass cannot be prevented even by the method described in NPL 1, and consequently ripples cannot be prevented.

Furthermore, it is difficult in the method described in NPL 1 to control the degree of etching and the refractive index. In addition, a residual soluble non-silicon-oxide-rich phase causes deterioration in water fastness and a problem, such as fogging, in optical members.

### CITATION LIST

### Patent Literature

PTL 1: Japanese Patent Laid-Open No. 01-083583

### Non Patent Literature

NPL 1: J. Opt. Soc. Am., Vol. 66, No. 6, 1976

### SUMMARY OF INVENTION

### Technical Problem

The present invention provides an optical member that includes a porous glass layer on a substrate and rarely causes ripples, and a method for easily manufacturing the optical member.

### Solution to Problem

An optical member according to the present invention includes a substrate and a porous glass layer disposed on the substrate. The porous glass layer includes a first porous glass layer and a second porous glass layer in this order on the substrate. The first porous glass layer has a uniform porosity. The second porous glass layer has a higher uniform porosity than the first porous glass layer.

A method for manufacturing an optical member according to the present invention is a method for manufacturing an optical member having a porous glass layer on a substrate. The method includes forming a phase-separable first base glass layer and a phase-separable second base glass layer on the substrate, the second base glass layer having a different composition from the first base glass layer, phase-separating the first base glass layer from the second base glass layer to form a first phase separation glass layer and a second phase separation glass layer on the substrate, and etching the first phase separation glass layer and the second phase separation glass layer to form a porous glass layer on the substrate, the porous glass layer including a first porous glass layer having a uniform porosity and a second porous glass layer having a uniform porosity in this order on the substrate, the second porous glass layer having a higher porosity than the first porous glass layer.

### Advantageous Effects of Invention

The present invention can provide an optical member that includes a porous glass layer on a substrate and rarely causes ripples, and a method for easily manufacturing the optical member.

Further features of the present invention will become apparent from the following description of exemplary embodiments with reference to the attached drawings.

### BRIEF DESCRIPTION OF DRAWINGS

FIG. 1 is a schematic cross-sectional view of an optical member according to an embodiment of the present invention.

FIG. 2 is a graph illustrating ripples.

FIG. 3 is a graph illustrating porosity.

FIG. 4A is a photograph illustrating the average pore size.

FIG. 4B is a photograph illustrating the average skeleton size.

FIG. 5 is a schematic view of an image pickup apparatus according to an embodiment of the present invention.

FIG. 6A is a schematic cross-sectional view of a method for manufacturing an optical member according to an embodiment of the present invention.

FIG. 6B is a schematic cross-sectional view of a method for manufacturing an optical member according to an embodiment of the present invention.

FIG. 6C is a schematic cross-sectional view of a method for manufacturing an optical member according to an embodiment of the present invention.

FIG. 6D is a schematic cross-sectional view of a method for manufacturing an optical member according to an embodiment of the present invention.

FIG. 7A is a schematic cross-sectional view of a method for manufacturing an optical member according to another embodiment of the present invention.

FIG. 7B is a schematic cross-sectional view of a method for manufacturing an optical member according to another embodiment of the present invention.

FIG. 7C is a schematic cross-sectional view of a method for manufacturing an optical member according to another embodiment of the present invention.

FIG. 7D is a schematic cross-sectional view of a method for manufacturing an optical member according to another embodiment of the present invention.

FIG. 7E is a schematic cross-sectional view of a method for manufacturing an optical member according to another embodiment of the present invention.

FIG. 7F is a schematic cross-sectional view of a method for manufacturing an optical member according to another embodiment of the present invention.

FIG. 8 is an electron micrograph of a cross section of a sample prepared in Example 4.

FIG. 9 is a graph showing the dependence of reflectance on wavelength in Examples 1 to 4 and Comparative Examples 1 to 3.

### DESCRIPTION OF EMBODIMENTS

The present invention will be further described in the following embodiments. Well-known or known techniques may be applied to components not illustrated or described in the present specification.

“Phase separation” for forming a porous structure in the present invention will be described below using borosilicate glass that contains silicon oxide, boron trioxide, and an alkali metal oxide as glass. “Phase separation”, as used herein, refers to separation between a phase containing increased amounts of alkali metal oxide and boron trioxide in glass after the phase separation (a non-silicon-oxide-rich phase) and another phase containing decreased amounts of alkali metal oxide and boron trioxide in glass after the phase separation (a silicon-oxide-rich phase). These phases have a structure in the range of several nanometers to several tens of micrometers. The non-silicon-oxide-rich phase in glass after phase separation is removed by etching to form a porous structure in the glass.

Phase separation includes spinodal and binodal phase separation. Porous glass manufactured by spinodal phase separation has through-holes extending from the surface to the interior. More specifically, a structure resulting from spinodal phase separation is a “formicary” structure having three-dimensionally interconnected pores, in which a silicon oxide skeleton forms “walls”, and the through-holes correspond to “interconnected pores”. Porous glass manufactured by binodal phase separation includes discrete closed pores, which are similar to spheres, each surrounded by a closed surface in a silicon oxide skeleton. Pores resulting from spinodal phase separation and pores resulting from binodal phase separation can be differentiated by morphological observation with an electron microscope. Whether spinodal phase separation or binodal phase separation depends on the composition of glass and phase separation temperature.

### Optical Member

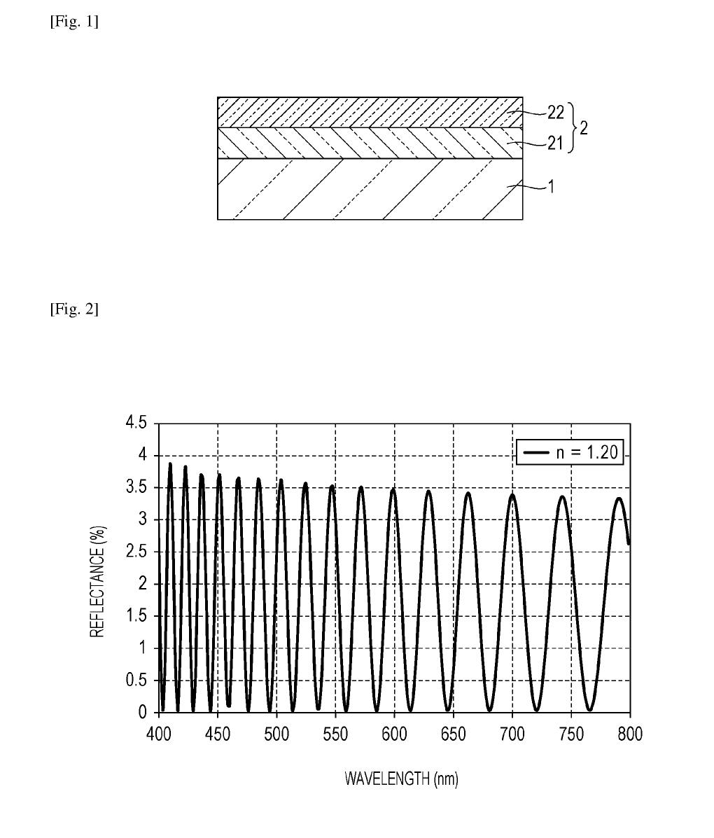

FIG. 1 is a schematic cross-sectional view of an optical member according to an embodiment of the present invention. An optical member according to the present invention includes a porous glass layer 2 on a substrate 1. The porous glass layer 2 has a continuous porous structure resulting from spinodal phase separation. The porous glass layer 2 has a low refractive index and can reduce reflection from the interface between the porous glass layer 2 and air (the top surface of the porous glass layer 2). Thus, the porous glass layer 2 is expected to be utilized in an optical member. However, in an optical member having the porous glass layer 2 on the substrate 1, light reflected from the top surface of the porous glass 2 interferes with light reflected from the interface between the substrate 1 and the porous glass 2. This may cause interference fringes of reflected light, called ripples. In particular, when the porous glass layer 2 has a thickness equal to or greater than the wavelength of light and less than several tens of micrometers, this interference effect is noticeable.

FIG. 2 illustrates reflectance as a function of wavelength. Ripples are represented by periodic variations like sine waves. The reflectance was calculated according to optical simulation for a structure that includes a porous glass layer having a thickness of 5 micrometers (having a refractive index of 1.20 at 550 nm) on a quartz glass substrate. The optical simulation was calculated with WVASE32 available from J. A. Woollam Japan Co., Inc. Such ripples may increase the dependence of reflectance on wavelength, making the porous glass layer unsuitable for use in optical members.

The porous glass layer 2 of an optical member according to an embodiment of the present invention includes a first porous glass layer 21 having a uniform porosity and a second porous glass layer 22 having a uniform porosity on the substrate 1 in this order. The second porous glass layer 22 has a higher porosity than the first porous glass layer 21.

Thus, the second porous glass layer 22 has a refractive index closer to the refractive index of the substrate 1 than the first porous glass layer 21. This can reduce a sharp change in refractive index and reduce reflection from the interface between the substrate 1 and the porous glass layer 2. This can reduce ripples caused by interference of light reflected from the top surface of the porous glass layer 2 with light reflected from the interface between the substrate 1 and the porous glass layer 2.

The term “uniform porosity”, as used herein with respect to a layer, means that variations in porosity in the thickness direction of the layer are less than 1%. In other words, the difference in porosity between any two portions in the layer is less than 1%. Furthermore, the difference in porosity at the interface between the first porous glass layer 21 and the second porous glass layer 22 is 1% or more. It is desirable that the difference in porosity between the first porous glass layer 21 and the second porous glass layer 22 be 1% or more and 30% or less so as to reduce reflectance. The difference in porosity is preferably 10% or less.

The porosity of the first porous glass layer 21 and the porosity of the second porous glass layer 22 satisfy the relationship described above and are preferably 20% or more and 70% or less, more preferably 20% or more and 50% or less. A porosity of less than 20% unfavorably results in an insufficient advantage of porosity. A porosity of more than 70% also unfavorably results in a low surface strength. The porosity of a porous glass layer of 20% or more and 70% or less corresponds to the refractive index of 1.10 or more and 1.40 or less.

In particular, in order to reduce the reflectance of the optical member, the porosity of the first porous glass layer 21 is preferably 20% or more and 50% or less, and the porosity of the second porous glass layer 22 is 30% or more and 70% or less.

The skeleton and pores in an electron micrograph image are binarized. More specifically, the surface of the porous glass layer 2 is observed with a scanning electron microscope (FE-SEM S-4800, manufactured by Hitachi, Ltd.) at an accelerating voltage of 5.0 kV at a magnification of 100,000 (or 50,000) at which it is easy to observe the skeleton on a gray scale.

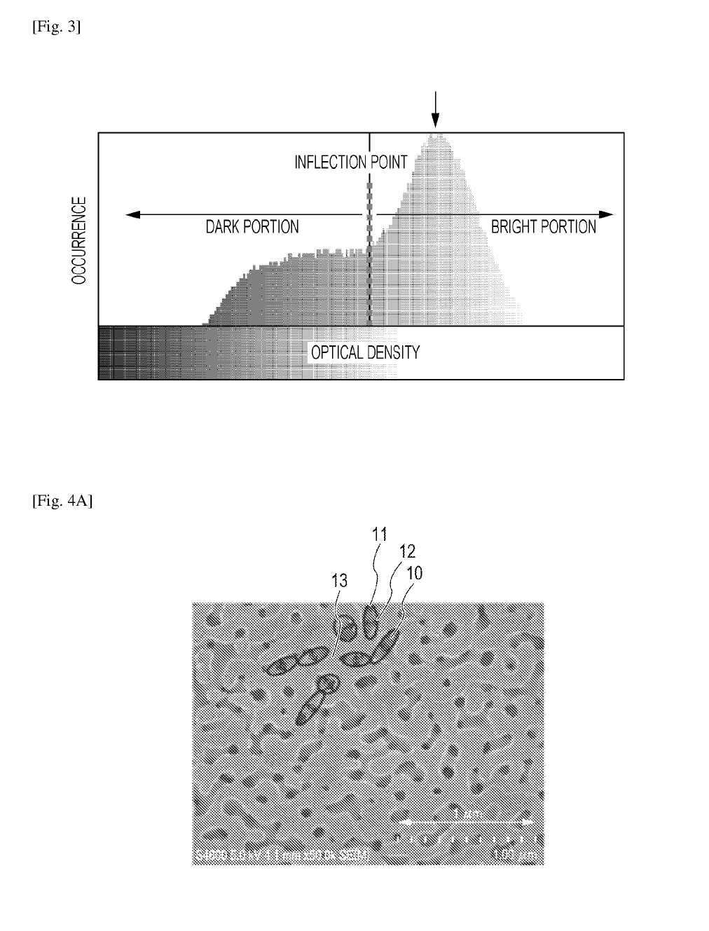

The observed SEM image is stored and is converted into a graph with image analysis software in accordance with optical density. FIG. 3 is a graph illustrating the occurrence of pores in a spinodal porous structure as a function of optical density. The optical density at the peak indicated by the down arrow in FIG. 3 corresponds to the skeleton on the front surface.

A bright portion (skeleton) and a dark portion (pores) are binarized into black and white using an inflection point close to the peak as a threshold. The ratio of a black area to the entire area (the total of white and black areas) is determined for each of the black areas in the image. The ratios are averaged to determine porosity.

The thickness of the porous glass layer 2 is, but not limited to, preferably 0.2 micrometers or more and 50.0 micrometers or less, more preferably 0.3 micrometers or more and 20.0 micrometers or less. When the thickness of the porous glass layer 2 is less than 0.2 micrometers, it is impossible to provide the porous glass layer 2 that can reduce ripples and has a high surface strength and a high porosity (a low refractive index). When the thickness of the porous glass layer 2 is more than 50.0 micrometers, the porous glass layer 2 is difficult to treat as an optical member because of its high haze.

The thickness of the first porous glass layer 21 is preferably 0.1 micrometers or more and 20.0 micrometers or less. The first porous glass layer 21 having a thickness of less than 0.1 micrometers has marginal effects, and the reflectance at the interface between the first porous glass layer 21 and the substrate 1 is almost the same as the reflectance in the case that the second porous glass layer 22 is in contact with the substrate 1. This tends to result in marginal effects on the reflection from the surface of the porous glass layer 2. The thickness of the first porous glass layer 21 is more preferably 0.1 micrometers or more and 1.0 micrometers or less. When the thickness of the first porous glass layer 21 is 1.0 micrometers or less, the dependence of reflectance on wavelength can be reduced.

The thickness of the second porous glass layer 22 is preferably 0.1 micrometers or more and 20.0 micrometers or less. The second porous glass layer 22 having a thickness of less than 0.1 micrometers has marginal effects, and the reflectance at the interface between the first porous glass layer 21 and the second porous glass layer 22 is almost the same as the reflectance at the interface between the second porous glass layer 22 and air.

The thickness of a porous glass layer is determined as follows: a SEM image (electron micrograph) is taken with a scanning electron microscope (FE-SEMS-4800, manufactured by Hitachi, Ltd.) at an accelerating voltage of 5.0 kV. The thickness of the glass layer on a substrate is measured at 30 or more points on the image. The thickness of the porous glass layer is the mean value of the measurements.

The first porous glass layer 21 may be in contact with the second porous glass layer 22. The porous glass layer 2 may include one or more porous glass layers on the second porous glass layer 22, provided that the porosity increases from the substrate 1 to the top surface of the porous glass layer 2. More specifically, in the case that a third porous glass layer is disposed on the second porous glass layer 22, the third porous glass layer has a higher porosity than the first porous glass layer 21 and may have a higher porosity than the second porous glass layer 22.

In the case that three or more porous glass layers having different porosities are stacked, the difference in porosity between adjacent layers is preferably 30% or less and is more preferably 10% or less in terms of low reflectance of an optical member.

An optical member according to an embodiment of the present invention may include a non-porous film on the porous glass layer 2. The non-porous film has a lower refractive index than the porous glass layer 2.

An optical member according to an embodiment of the present invention may include a gradient porosity layer between the first porous glass layer 21 and the second porous glass layer 22. The gradient porosity layer has porosities of 1 nm or more and 10 nm or less.

The average pore size of the porous glass layer 2 is preferably 1 nm or more and 100 nm or less, more preferably 5 nm or more and 50 nm or less. The porous glass layer 2 having an average pore size of less than 1 nm cannot take advantage of the porous structure. An average pore size of more than 100 nm may unfavorably result in a low surface strength. An average skeleton size of 50 nm or less advantageously results in reduced light scattering. The average skeleton size can be smaller than the thickness of the porous glass layer 2.

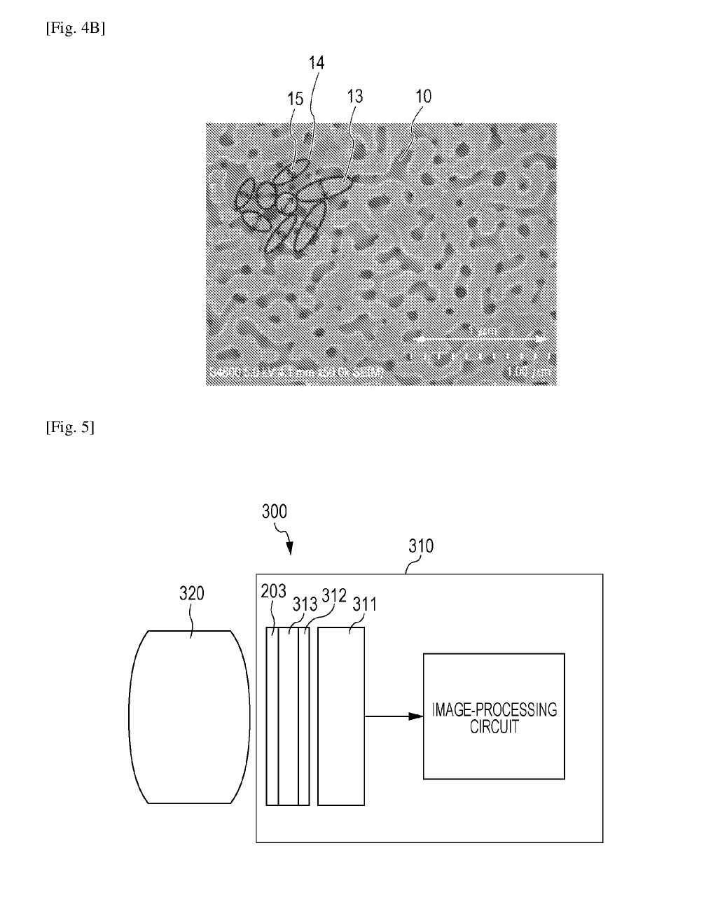

The term “average pore size”, as used herein, refers to the mean length of the minor axes of ellipses each corresponding to a pore in a porous body surface. More specifically, as illustrated in FIG. 4A, the average pore size can be determined by calculating the mean length of the minor axes 12 of ellipses 11 each corresponding to a pore 10 in an electron micrograph of a porous body surface. The mean length is calculated from at least 30 measurements.

The average pore sizes of the first porous glass layer 21 and the second porous glass layer 22 may be different or the same.

The average skeleton size of the porous glass layer 2 is preferably 1 nm or more and 500 nm or less, more preferably 5 nm or more and 50 nm or less. An average skeleton size of more than 100 nm results in marked light scattering and much decreased transmittance. An average skeleton size of less than 1 nm may result in a low strength of the porous glass layer 2. An average skeleton size of more than 500 nm results in poor denseness and a low strength of the porous glass layer 2.

The term “average skeleton size”, as used herein, refers to the mean length of the minor axes of ellipses each corresponding to a skeleton of a porous body surface. More specifically, as illustrated in FIG. 4B, the average skeleton size can be determined by calculating the mean length of the minor axes 15 of ellipses 14 each corresponding to a skeleton 13 in an electron micrograph of a porous body surface. The mean length is calculated from at least 30 measurements.

The average skeleton sizes of the first porous glass layer 21 and the second porous glass layer 22 may be different or the same. The second porous glass layer 22 preferably has a larger average skeleton size than the first porous glass layer 21. When the second porous glass layer 22 has a larger average skeleton size than the first porous glass layer 21, the resulting glass layer may have a high strength of the surface.

It should be noted that light scattering is affected by various factors including the thickness of an optical member and does not uniquely depend on the pore size and the skeleton size. The pore size and the skeleton size of the porous glass layer 2 can be controlled via the raw materials and heat-treatment conditions in spinodal phase separation.

The substrate 1 may be made of any material suitable for each purpose. The material of the substrate 1 may be quartz glass or rock crystal in terms of transparency, heat resistance, and strength. The substrate 1 may have a layered structure composed of different materials. The substrate 1 has no pores and is a non-porous member.

The substrate 1 may be transparent. The substrate 1 preferably has a transmittance of 50% or more, more preferably 60% or more, in the visible light region (a wavelength range of 450 nm or more and 650 nm or less). A transmittance of less than 50% may cause a problem when the substrate 1 is used as an optical member. The substrate 1 may be made of a material for low-pass filters or lenses.

An optical member according to an embodiment of the present invention may be used in various displays for television sets and computers, polarizers for liquid crystal displays, viewing lenses for cameras, prisms, fly-eye lenses, and toric lenses, and various lenses for image-taking optical systems using these optical members, optical systems for observation, such as binoculars, projection optical systems for liquid crystal projectors, and scanning optical systems for laser-beam printers.

An optical member according to an embodiment of the present invention may be used in image pickup apparatuses, such as digital cameras and digital video cameras. FIG. 5 is a schematic cross-sectional view of a camera (image pickup apparatus) including an optical member according to an embodiment of the present invention, more specifically, an image pickup apparatus configured to form an object image on an image pickup element through a lens and an optical filter. An image pickup apparatus 300 includes a main body 310 and a detachable lens 320. An image pickup apparatus, such as a digital single-lens reflex camera, can take images at various field angles through image-taking lenses having different focal lengths. The main body 310 includes an image pickup element 311, an infrared cut filter 312, a low-pass filter 313, and an optical member 203 according to an embodiment of the present invention. The optical member 203 includes a substrate 1 and a porous glass layer 2, as illustrated in FIG. 1.

The optical member 203 and the low-pass filter 313 may be united or disunited. The optical member 203 may also serve as a low-pass filter. More specifically, the substrate 1 of the optical member 203 may serve as a low-pass filter.

The image pickup element 311 is hermetically sealed in a package (not shown) with a coverglass (not shown). The space between the optical filters, such as the low-pass filter 313 and the infrared cut filter 312, and the coverglass is hermetically sealed with a sealing member, such as a double-sided tape (not shown). The optical filter may be one of the low-pass filter 313 and the infrared cut filter 312.

The porous glass layer 2 of the optical member 203 has a spinodal porous structure and consequently is highly dustproof, for example, it is capable of preventing dust adhesion. Thus, the optical member 203 is disposed on the optical filter opposite the image pickup element 311. The optical member 203 may be disposed such that the porous glass layer 2 is further away from image pickup element 311 than the substrate 1. In other words, the optical member 203 may be disposed such that the substrate 1 and the porous glass layer 2 are disposed on the image pickup element 311 in this order.

### Method for Manufacturing Optical Member

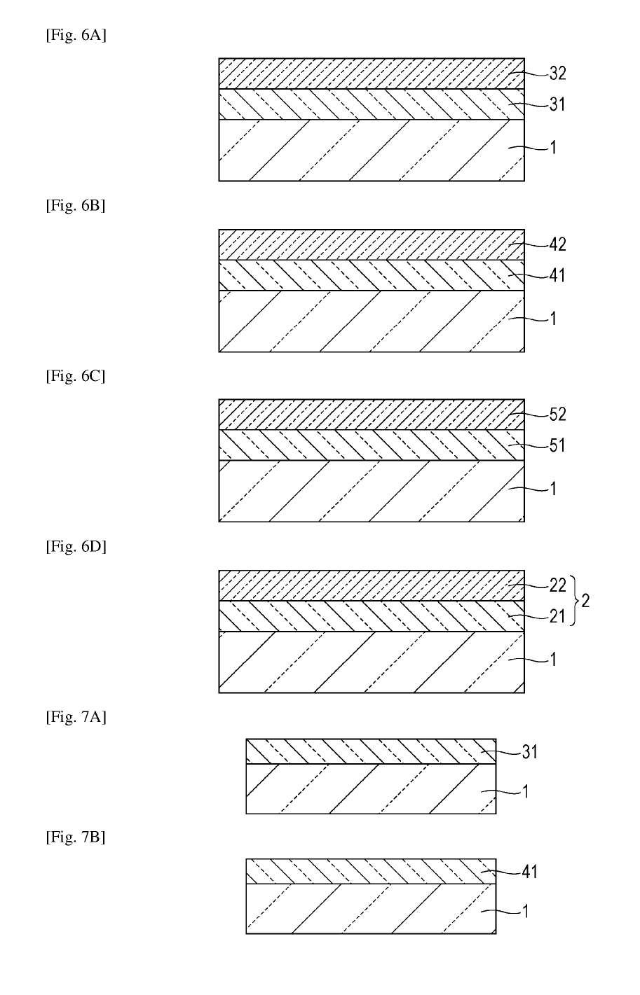

FIGS. 6A to 6D are schematic views of a method for manufacturing an optical member according to an embodiment of the present invention. An optical member according to an embodiment of the present invention includes a porous glass layer on a substrate and is manufactured as described below. First, a first glass powder layer and a second glass powder layer are formed on the substrate. The second glass powder layer has a different composition from the first glass powder layer. The first glass powder layer and the second glass powder layer are heated and fused to form a phase-separable first base glass layer and a phase-separable second base glass layer, respectively. The first base glass layer and the second base glass layer are subjected to phase separation treatment and are etched to form a first porous glass layer having a uniform porosity and a second porous glass layer having a uniform porosity in this order on the substrate. The second porous glass layer has a higher porosity than the first porous glass layer. The manufacturing method will be described in detail below with reference to FIGS. 6A to 6D.

### Process of Forming First Glass Powder Layer and Second Glass Powder Layer

First, as illustrated in FIG. 6A, a first glass powder layer 31 and a second glass powder layer 32 are formed on the substrate 1. The first glass powder layer 31 and the second glass powder layer 32 have different compositions. These compositions are determined such that a first porous glass layer 21 formed later has a lower porosity than a second porous glass layer 22 formed later. In general, the silicon oxide content is higher in the first glass powder layer 31 than in the second glass powder layer 32. However, depending on the type of another component, the compositions of the first glass powder layer 31 and the second glass powder layer 32 do not depend on the silicon oxide content alone. Thus, the compositions of the first glass powder layer 31 and the second glass powder layer 32 are appropriately determined for each optical member.

The first glass powder layer 31 and the second glass powder layer 32 can be formed by any film-forming method, such as printing, vacuum evaporation, sputtering, spin coating, or dip coating. Among these, screen printing can be used to form a glass powder layer having any glass composition. A common screen printing method will be described below. Screen printing is performed with a screen printing machine using a glass powder paste. Thus, the glass powder paste must be prepared.

Base glass for the glass powder can be manufactured by a known method. The raw materials are prepared so as to satisfy the composition of intended glass, such as borosilicate glass. For example, the base glass can be manufactured by melting the raw materials containing component sources and, if necessary, shaping the molten product into a desired form. The heating temperature for melting may depend on the raw material composition and is generally in the range of 1350 to 1450 degrees Celsius, preferably 1380 to 1430 degrees Celsius.

In order to prepare the paste, the base glass is converted into a glass powder. The glass powder may be manufactured by any known method. Examples of the method include liquid-phase pulverization using a bead mill and gas-phase pulverization using a jet mill. In addition to the glass powder, the paste contains a thermoplastic resin, a plasticizer, and a solvent.

The composition of the glass powder for the first glass powder layer 31 differs from the composition of the glass powder for the second glass powder layer 32. Thus, at least two glass powders are prepared.

The glass powder content of the paste may be 30.0% by weight or more and 90.0% by weight or less, preferably 35.0% by weight or more and 70.0% by weight or less.

The thermoplastic resin in the paste can increase the film strength after drying and impart flexibility to the film. Examples of the thermoplastic resin include poly(butyl methacrylate), poly(vinyl butyral), poly(methyl methacrylate), poly(ethyl methacrylate), and ethylcellulose. These thermoplastic resins may be used alone or in combination.

Examples of the plasticizer in the paste include butyl benzyl phthalate, dioctyl phthalate, diisooctyl phthalate, dicapryl phthalate, and dibutyl phthalate. These plasticizers may be used alone or in combination.

Examples of the solvent in the paste include terpineol, diethylene glycol monobutyl ether acetate, and 2,2,4-trimethyl-1,3-pentanediol monoisobutyrate. These solvents may be used alone or in combination.

The paste can be prepared by mixing these materials in a predetermined ratio. Two pastes each containing different glass powders are prepared. Three or more pastes each containing different glass powders may be prepared. Although two glass powder layers are formed in the following embodiment, three or more glass powder layers may be formed.

Two of the pastes thus prepared are successively applied to the substrate 1 by screen printing to form two glass powder layers. More specifically, a first paste is applied and is dried to remove the solvent, thereby forming the first glass powder layer 31. A second paste is then applied and is dried to remove the solvent, thereby forming the second glass powder layer 32. Each of these pastes may be repeatedly applied and dried to achieve a desired thickness.

The temperature and time for removing the solvent may depend on the type of solvent. However, it is desirable to dry the pastes at a temperature lower than the decomposition temperature of the thermoplastic resin. When the drying temperature is higher than the decomposition temperature of the thermoplastic resin, the glass particles are difficult to fix, and the resulting glass powder layers may have defects or a rough surface.

Use of the substrate 1 can reduce the strain of the glass layers caused by heat treatment in the phase separation process and facilitates the thickness control of a porous glass layer 2.

The softening temperature of the substrate 1 is preferably equal to or greater than the heating temperature in the phase separation process described below (phase separation temperature) and is more preferably equal to or greater than the phase separation temperature+100 degrees Celsius. In the case that the substrate is made of crystals, however, the softening temperature is the melting temperature. When the softening temperature is lower than the phase separation temperature, the substrate 1 may be deformed in the phase separation process. The term “phase separation temperature”, as used herein, refers to the maximum heating temperature for spinodal phase separation.

It is desirable that the substrate 1 be resistant to etching of a phase separation glass layer described below.

### Process of Forming First Base Glass Layer and Second Base Glass Layer

As illustrated in FIG. 6B, the first glass powder layer 31 and the second glass powder layer 32 are heated to fuse the glass powders, thereby forming a phase-separable first base glass layer 41 and a phase-separable second base glass layer 42 on the substrate 1. The term “phase-separable”, as used herein, means that the phase separation described above can occur at a certain heating temperature. The first base glass layer 41 and the second base glass layer 42 have different compositions.

In order to fuse the glass powder layers, it is desirable to perform heat treatment at a temperature of at least the glass transition temperature of the glass powder layers. Heat treatment at a temperature lower than the glass transition temperature tends to result in insufficient fusion of the powder and the formation of a rough glass layer. The term “the glass transition temperature of glass powder layers”, as used herein, refers to the highest one of the glass transition temperatures of the glass powder layers. In the case of the structure illustrated in FIG. 6A, the glass transition temperature of the glass powder layers is the higher one out of the glass transition temperature of the first glass powder layer 31 and the glass transition temperature of the second glass powder layer 32.

The glass transition temperature of the glass powder layers is defined by the glass transition temperatures of the glass powders in the glass powder layers. The glass transition temperatures of the glass powders can be determined from a DTA curve obtained by thermogravimetry-differential thermal analysis (TG-DTA). An exemplary measuring apparatus is Thermoplus TG8120 (Rigaku Corp.). More specifically, the DTA curve is obtained by heating a glass powder in a platinum pan from room temperature at a heating rate of 10 degrees Celsius/minute. In the DTA curve, a starting temperature of an endothermic peak is determined by extrapolation using a tangent line method. The starting temperature is considered to be the glass transition temperature (Tg) of the glass powder.

When heated at high temperature, the glass powder layers can be softened and mixed together to form a single glass layer. Thus, a plurality of phase-separable base glass layers cannot be formed. The single glass layer results in a known structure that includes a porous glass layer on a substrate and cannot reduce ripples. It is therefore desirable to perform heat treatment in the fusion of the glass powder layers at a temperature at which such mixing rarely occurs. For example, it is desirable to perform the heat treatment at a temperature lower than the glass transition temperature of the glass powder layers+500 degrees Celsius.

Heating for fusion may be performed by a known heat treatment method. The heat treatment method may involve the use of an electric furnace, an oven, or infrared radiation. Any heating methods, including convective, radiant, and electric heating methods, may be used.

The solvent of the paste may be removed simultaneously with the fusion of the glass powder layers.

Process of Forming First Phase Separation Glass Layer and Second Phase Separation Glass Layer

As illustrated in FIG. 6C, the first base glass layer 41 and the second base glass layer 42 are subjected to phase separation to form a first phase separation glass layer 51 and a second phase separation glass layer 52 on the substrate 1.

More specifically, the phase separation process for forming the phase separation glass layers is performed at a temperature of 450 degrees Celsius or more and 750 degrees Celsius or less for several hours to several tens of hours. The heating temperature in the phase separation process is not necessarily fixed and may be continuously or stepwise changed. The phase separation treatment is performed at a temperature at which the first base glass layer 41 and the second base glass layer 42 simultaneously undergo phase separation.

It is desirable that heating in the phase separation treatment is performed at a temperature at which the first base glass layer 41 and the second base glass layer 42 are rarely mixed together. More specifically, the first base glass layer 41 and the second base glass layer 42 are rarely mixed together at a temperature lower than the glass transition temperature of the glass powder layers+500 degrees Celsius.

The porosities of a first porous glass layer 21 and a second porous glass layer 22 described below can be controlled via the phase separation treatment time. More specifically, the percentage and the size of a non-silicon-oxide-rich phase can be controlled by utilizing a difference in phase separation rate between the first base glass layer 41 and the second base glass layer 42. Thus, etching described below can form pores depending on the percentage and the size of a non-silicon-oxide-rich phase and form a porous glass layer having a desired porosity.

Heating in the phase separation treatment may be performed by a known heat treatment method. The heat treatment method may involve the use of an electric furnace, an oven, or infrared radiation. Any heating methods, including convective, radiant, and electric heating methods, may be used.

### Process of Forming Porous Glass Layer

Finally, as illustrated in FIG. 6D, the first phase separation glass layer 51 and the second phase separation glass layer 52 are etched to form the first porous glass layer 21 and the second porous glass layer 22 on the substrate 1. The first porous glass layer 21 and the second porous glass layer 22 constitute the porous glass layer 2. The porous glass layer 2 includes the first porous glass layer 21 having a uniform porosity and the second porous glass layer 22 having a uniform porosity on the substrate 1 in this order. The second porous glass layer 22 has a higher porosity than the first porous glass layer 21.

The non-silicon-oxide-rich phase in the phase separation glass layers can be removed by etching while a silicon-oxide-rich phase remains. The silicon-oxide-rich phase forms the skeleton of the porous glass layer 2, and the portion from which the nonsilicon-oxide-rich phase has been removed forms pores of the porous glass layer 2.

In etching for removing the non-silicon-oxide-rich phase, the water-soluble nonsilicon-oxide-rich phase is generally eluted by bringing it into contact with an aqueous solution. A glass layer is generally brought into contact with the aqueous solution by immersing the glass layer in the aqueous solution. However, any method for bringing a glass layer into contact with an aqueous solution may be used. For example, an aqueous solution is applied to a glass layer. An aqueous solution required for etching may be an existing solution that can solve the non-silicon-oxide-rich phase, such as water, an acid solution, or an alkaline solution. For some applications, processes of bringing a glass layer into contact with an aqueous solution may be used in combination.

The aqueous solution may be a solution of an acid, for example, an inorganic acid, such as hydrochloric acid or nitric acid. The concentration of the acid solution may be in the range of 0.1 to 2.0 mol/L. In an acid treatment process using the acid solution, the acid solution temperature may be in the range of room temperature to 100 degrees Celsius, and the processing time may be in the range of approximately 1 to 500 hours.

Depending on the glass composition and the manufacturing conditions, a silicon oxide layer having a thickness of several tens of nanometers may be formed on a glass surface after heat treatment for phase separation. The silicon oxide layer may inhibit etching. The silicon oxide layer on the surface may be removed by polishing or alkaline treatment.

Treatment with an acid solution or an alkaline solution (an etching process 1) may be followed by water treatment (an etching process 2). The water treatment can decrease the deposit of residual components on the porous glass skeleton and tends to provide a porous glass having an increased porosity.

The water treatment temperature may generally be in the range of room temperature to 100 degrees Celsius. The water treatment time depends on the composition and the size of the grass and may be in the range of approximately 1 to 50 hours.

### Another Method for Manufacturing Optical Member

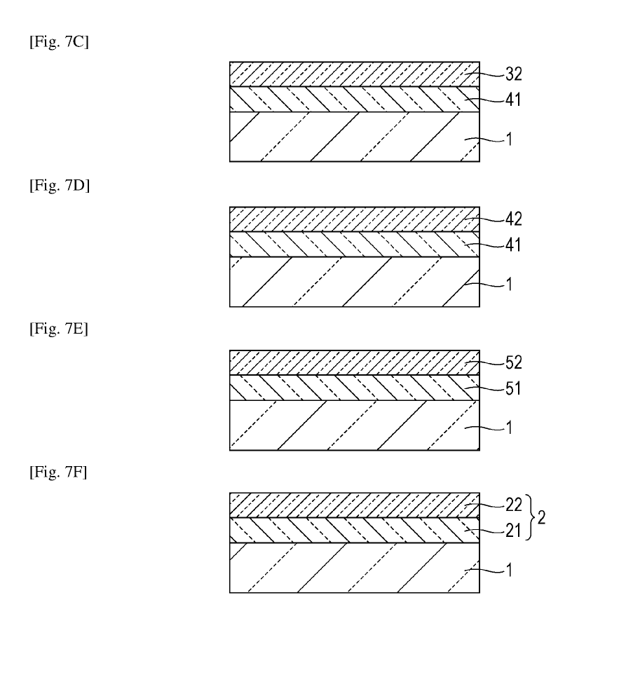

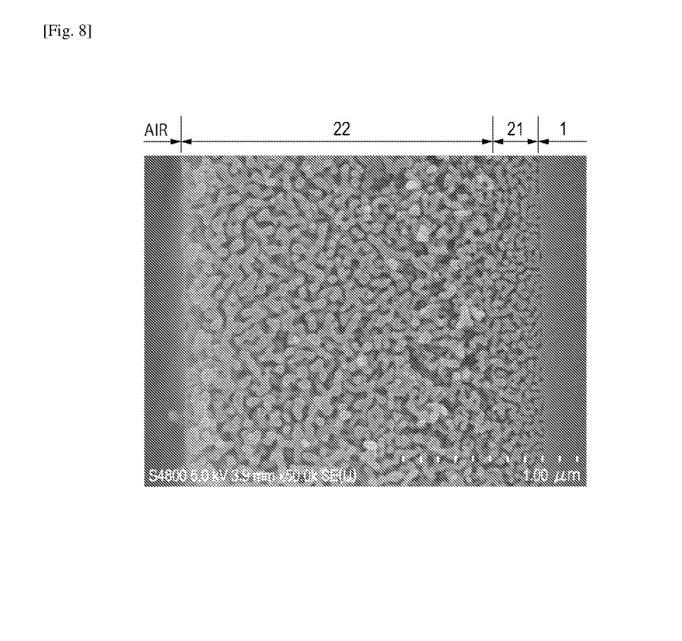

FIGS. 7A to 7F are schematic views of a method for manufacturing an optical member according to another embodiment of the present invention. First, a first glass powder layer is formed on a substrate, is heated, and is fused to form a phase-separable first base glass layer on the substrate. A second glass powder layer is then formed on the first base glass layer, is heated, and is fused to form a phase-separable second base glass layer having a different composition from the first base glass layer. The first base glass layer and the second base glass layer are subjected to phase separation treatment and are etched to form a first porous glass layer having a uniform porosity and a second porous glass layer having a uniform porosity in this order on the substrate. The second porous glass layer has a higher porosity than the first porous glass layer. The manufacturing method will be described in detail below with reference to FIGS. 7A to 7F. The conditions that have already been described for the manufacturing method illustrated in FIGS. 6A to 6D will be omitted.

### Process of Forming First Glass Powder Layer

First, as illustrated in FIG. 7A, a first glass powder layer 31 is formed on a substrate 1. The first glass powder layer 31 may be formed by the screen printing of a glass paste as described above.

### Process of Forming First Base Glass Layer

As illustrated in FIG. 7B, the first glass powder layer 31 is heated to fuse the glass powder, thereby forming a phase-separable first base glass layer 41 on the substrate 1.

### Process of Forming Second Glass Powder Layer

As illustrated in FIG. 7C, a second glass powder layer 32 having a different composition from the first glass powder layer 31 is formed on the first base glass layer 41.

### Process of Forming Second Base Glass Layer

As illustrated in FIG. 7D, the second glass powder layer 32 is heated to fuse the glass powder, thereby forming a phase-separable second base glass layer 42 on the first base glass layer 41. The glass powder in the second glass powder layer 32 is different from the glass powder in the first glass powder layer 31. Thus, the compositions of the first base glass layer 41 and the second base glass layer 42 are also different.

In this process, in order to prevent the first base glass layer 41 from melting and mixing with the second base glass layer 42 to form a single glass layer, the heating and fusion may be performed at the following temperature. That is, it is desirable to perform the heat treatment at a temperature lower than the glass transition temperature of the glass powder layers+500 degrees Celsius. The glass transition temperature of the glass powder layers is defined above.

### (Process of Forming First Phase Separation Glass Layer and Second Phase Separation Glass Layer)

As illustrated in FIG. 7E, the first base glass layer 41 and the second base glass layer 42 are subjected to phase separation to form a first phase separation glass layer 51 and a second phase separation glass layer 52 on the substrate 1.

(Process of Forming Porous Glass Layer)

Finally, as illustrated in FIG. 7F, the first phase separation glass layer 51 and the second phase separation glass layer 52 are etched to form the first porous glass layer 21 and the second porous glass layer 22 on the substrate 1. The first porous glass layer 21 and the second porous glass layer 22 constitute the porous glass layer 2. The porous glass layer 2 includes the first porous glass layer 21 having a uniform porosity and the second porous glass layer 22 having a uniform porosity on the substrate 1 in this order. The second porous glass layer 22 has a higher porosity than the first porous glass layer 21.

### EXAMPLES

Although the present invention will be further described in the following examples, the present invention is not limited to these examples.

### Substrate A

A substrate A was a mirror-polished 50 mm×50 mm quartz substrate (manufactured by Iiyama Precision Glass Co., Ltd., softening point 1700 degrees Celsius, Young's modulus 72 GPa) having a thickness of 0.5 mm

### Preparation of Glass Powder A

A mixed powder of quartz, boron trioxide, sodium oxide, and alumina having a composition of SiO₂ 64.0% by weight, B₂O₃ 27.0% by weight, Na₂O 6.0% by weight, and Al₂O₃ 3.0% by weight was melted in a platinum crucible at 1500 degrees Celsius for 24 hours. The resulting glass was cooled to 1300 degrees Celsius and was poured into a graphite mold. The glass was quenched in the air with a twin roller to yield a glass frit. The resulting borosilicate glass frit was pulverized with a liquid phase bead mill to produce a glass powder A having an average particle size of 4.5 micrometers. The glass powder A had a glass transition temperature of 470 degrees Celsius.

### Preparation of Glass Powder B

A glass powder B was prepared in the same manner as in the glass powder A except that a mixed powder of quartz, boron trioxide, sodium oxide, alumina, and potassium oxide having a composition of SiO₂ 58.7% by weight, B₂O₃ 30.4% by weight, Na₂O 8.1% by weight, Al₂O₃ 1.5% by weight, and K₂O 1.3% by weight was used. The glass powder B had a glass transition temperature of 460 degrees Celsius.

### Preparation of Glass Paste A

Glass powder A 60.0 parts by mass

Terpineol 44.0 parts by mass

Ethylcellulose (registered trademark ETHOCEL Std 200 (manufactured by The Dow Chemical Company)) 2.0 parts by mass

These raw materials were mixed to prepare a glass paste A. The glass paste A had a viscosity of 32400 mPa*s.

### Preparation of Glass Paste B

A glass paste B was prepared in the same manner as in the glass paste A except that the glass powder A was replaced with the glass powder B. The glass paste B had a viscosity of 35000 mPa*s.

### Example 1

The glass paste A was applied to the substrate A by screen printing. A printer MT-320TV manufactured by Micro-tec Co., Ltd. was used. A #500 30 mm×30 mm screen frame was used. The solvent was evaporated in a drying furnace at 100 degrees Celsius for 10 minutes to form a glass powder layer A.

The glass paste B was applied to the glass powder layer A by screen printing and was placed in a drying furnace at 100 degrees Celsius for 10 minutes to evaporate the solvent, thereby forming a glass powder layer B. Thus, the resulting layered structure included the glass powder layer A and the glass powder layer B on the substrate A.

The layered structure including the glass powder layer A and the glass powder layer B had a thickness of 10.0 micrometers as measured by SEM.

In a heat-treatment process 1, the structure was heated to 700 degrees Celsius at a heating rate of 5 degrees Celsius/minute, was heat-treated at this temperature for one hour, and was cooled to room temperature.

In a subsequent heat-treatment process 2, the structure was heated to 600 degrees Celsius at a heating rate of 20 degrees Celsius/minute, was heat-treated at this temperature for 50 hours to undergo phase separation, and was cooled to room temperature. The outermost surface of the structure was polished.

The structure after the phase separation was immersed in an 1.0 mol/L aqueous nitric acid at 80 degrees Celsius for 24 hours. The structure was then immersed in distilled water at 80 degrees Celsius for 24 hours. The structure was removed from the solution and was dried at room temperature for 12 hours to yield a sample 1. The sample 1 had a porous glass layer 2. The porous glass layer 2 of the sample 1 was observed. A first porous glass layer 21 and a second porous glass layer 22 had a thickness of 5.1 and 1.5 micrometers, respectively.

Table 1 listed the manufacturing conditions for the sample 1. Table 2 listed the structural measurements.

### Example 2

The glass paste A was applied to the substrate A by screen printing. A printer MT-320TV manufactured by Micro-tec Co., Ltd. was used. A #500 30 mm×30 mm screen frame was used. The product was then heated to 700 degrees Celsius at a heating rate of 5 degrees Celsius/minute and was held at this temperature for one hour, thereby forming a base glass layer A in which a glass powder was fused.

The glass paste B was applied to the base glass layer A by screen printing and was placed in a drying furnace at 100 degrees Celsius for 10 minutes to evaporate the solvent, thereby forming a glass powder layer B. Thus, the resulting layered structure included the base glass layer A and the glass powder layer B on the substrate A.

Subsequently, the process described in Example 1 was performed to yield a sample 2. The porous glass layer 2 of the sample 2 was observed. The first porous glass layer 21 and the second porous glass layer 22 had a thickness of 4.8 and 1.4 micrometers, respectively.

Table 1 listed the manufacturing conditions for the sample 2. Table 2 listed the structural measurements.

### Example 3

A sample 3 was prepared in the same manner as in Example 2 except that the polishing conditions were changed. Table 1 listed the manufacturing conditions for the sample 3. Table 2 listed the structural measurements.

FIG. 8 is an electron micrograph (SEM image) of the interface between the porous glass layer 2 and the substrate 1 of the sample 3. The first porous glass layer 21 and the second porous glass layer 22 had a thickness of 0.3 and 1.7 micrometers, respectively.

### Example 4

A sample 4 was prepared in the same manner as in Example 1 except that the heat-treatment process 1 involved heating to 900 degrees Celsius at a heating rate of 5 degrees Celsius/minute, heat treatment for one hour, and cooling to room temperature. The first porous glass layer 21 and the second porous glass layer 22 had a thickness of 7.2 and 1.2 micrometers, respectively.

Table 1 listed the manufacturing conditions for the sample 4. Table 2 listed the structural measurements.

### Comparative Example 1

A sample 5 was prepared in the same manner as in Example 1 except that the glass paste A was replaced with the glass paste B and the glass paste B was replaced with the glass paste A. The sample 5 included a porous glass layer having a high porosity and a porous glass layer having a low porosity on the substrate in this order. Table 1 listed the manufacturing conditions for the sample 5. Table 2 listed the structural measurements.

### Comparative Example 2

A sample 6 was prepared in the same manner as in Example 1 except that the glass paste B was replaced with the glass paste A.

The sample 6 included a single porous glass layer having a uniform porosity on the substrate. Table 1 listed the manufacturing conditions for the sample 6. Table 2 listed the structural measurements.

### Comparative Example 3

A sample 7 was prepared in the same manner as in Example 2 except that the glass paste A was replaced with the glass paste B. The sample 7 included a single porous glass layer having a uniform porosity on the substrate. Table 1 listed the manufacturing conditions for the sample 7. Table 2 listed the structural measurements.

### Comparative Example 4

A mixed powder of quartz, boron trioxide, sodium oxide, and alumina having a composition of SiO₂ 64.0% by weight, B₂O₃ 27.0% by weight, Na₂O 6.0% by weight, and Al₂O₃ 3.0% by weight was melted in a platinum crucible at 1500 degrees Celsius for 24 hours.

The resulting glass was cooled to 1300 degrees Celsius and was poured into a graphite mold. The glass was cooled in the air for approximately 20 minutes, was placed in a lehr at 500 degrees Celsius for 5 hours, and was cooled for 24 hours.

The resulting borosilicate glass block was cut in a size of 30 mm×30 mm×400 micrometers, and the both faces of the glass block were polished to yield a glass body A.

The glass paste B was applied to the glass body A, was placed in a drying furnace at 100 degrees Celsius for 10 minutes to evaporate the solvent, was heated to 700 degrees Celsius at a heating rate of 5 degrees Celsius/minute, was heat-treated at this temperature for one hour, and was cooled to room temperature. The resulting structure was heated to 600 degrees Celsius at a heating rate of 20 degrees Celsius/minute and was heat-treated at 600 degrees Celsius for 50 hours. The outermost surface of the structure was then polished.

The structure after the phase separation was immersed in an 1.0 mol/L aqueous nitric acid at 80 degrees Celsius for 24 hours. The structure was then immersed in distilled water at 80 degrees Celsius for 24 hours. The glass body was removed from the solution and was dried at room temperature for 12 hours to yield a sample 8.

The sample 8 had a warp and a low strength. Table 1 listed the manufacturing conditions for the sample 8. Table 2 listed the structural measurements.

### Comparative Example 5

A sample 9 was prepared in the same manner as in Example 1 except that the heat-treatment process 1 involved heating to 1000 degrees Celsius at a heating rate of 5 degrees Celsius/minute, heat treatment for one hour, and cooling to room temperature.

The sample 9 had no layered structure of the first porous glass layer 21 and the second porous glass layer 22. Table 1 listed the manufacturing conditions for the sample 9. Table 2 listed the structural measurements.

TABLE 1

| | | | | | | | Compar- | Compar- | Compar- | Compar- | Compar- |
|---|---|---|---|---|---|---|---|---|---|---|---|
| | | | | | | | ative | ative | ative | ative | ative |
| | | | Example | Example | Example | Example | Example | Example | Example | Example | Example |
| | | | 1 | 2 | 3 | 4 | 1 | 2 | 3 | 4 | 5 |
| | | | Substrate | Substrate | Substrate | Substrate | Substrate | Substrate | Substrate | Glass | Substrate |
| Substrate | | Type | A | A | A | A | A | A | A | substrate A | A |
| Components | Glass | Glass paste | Paste A | Paste A | Paste A | Paste A | Paste B | Paste A | Paste B | Paste B | Paste A |
| of glass layer | layer | Glass | 470 | 470 | 470 | 470 | 460 | 470 | 460 | 500 | 470 |
| | A | transition | | | | | | | | | |
| | | temperature | | | | | | | | | |
| | | (degree | | | | | | | | | |
| | | Celsius) | | | | | | | | | |
| | Glass | Glass paste | Paste B | Paste B | Paste B | Paste B | Paste A | — | — | — | Paste B |
| | layer | Glass | 460 | 460 | 460 | 460 | 470 | — | — | — | 460 |
| | B | transition | | | | | | | | | |
| | | temperature | | | | | | | | | |
| | | (degree | | | | | | | | | |
| | | Celsius) | | | | | | | | | |
| Heat | Fusion | Temperature | 700 | 700 | 700 | 900 | 700 | 700 | 700 | 700 | 1000 |
| treatment | process | (degree | | | | | | | | | |
| conditions | 1 | Celsius) | | | | | | | | | |
| | | Time (hr) | 1 | 1 | 1 | 1 | 1 | 1 | 1 | 1 | 1 |
| | Fusion | Temperature | — | 700 | 700 | — | — | — | — | — | — |
| | process | (degree | | | | | | | | | |
| | 2 | Celsius) | | | | | | | | | |
| | | Time (hr) | — | 1 | 1 | — | — | — | — | — | — |
| | Phase | Temperature | 600 | 600 | 600 | 600 | 600 | 600 | 600 | 600 | 600 |
| | separation | (degree | | | | | | | | | |
| | process | Celsius) | | | | | | | | | |
| | | Time (hr) | 50 | 50 | 50 | 50 | 50 | 50 | 50 | 50 | 50 |

TABLE 2

| | | | Example | Example | Example | Example | Comparative | Comparative | Comparative | Comparative | Comparative |
|---|---|---|---|---|---|---|---|---|---|---|---|
| | | | 1 | 2 | 3 | 4 | Example 1 | Example 2 | Example 3 | Example 4 | Example 5 |
| Substrate | | Porosity (%) | — | — | — | — | — | — | — | 44 | — |
| Glass | Glass | Porosity (%) | 41 | 41 | 40 | 25 | 47 | 43 | 48 | 47 | 24 |
| layer | layer | Pore size (nm) | 36 | 34 | 32 | 27 | 55 | 32 | 54 | 57 | 23 |
| | A | Skeleton size | 39 | 35 | 32 | 40 | 36 | 37 | 35 | 38 | 37 |
| | | (nm) | | | | | | | | | |
| | | Thickness | 5.1 | 4.8 | 0.3 | 7.2 | 1.9 | 11.5 | 4.2 | 1.5 | 11.2 |
| | | (micrometer) | | | | | | | | | |
| | Glass | Porosity (%) | 46 | 49 | 48 | 30 | 41 | — | — | — | — |
| | layer | Pore size (nm) | 51 | 59 | 58 | 25 | 33 | — | — | — | — |
| | B | Skeleton size | 42 | 35 | 35 | 32 | 35 | — | — | — | — |
| | | (nm) | | | | | | | | | |
| | | Thickness | 1.5 | 1.4 | 1.7 | 2.1 | 4.4 | — | — | — | — |
| | | (micrometer) | | | | | | | | | |

### Evaluation

The samples according to Examples 1 to 4 and Comparative Examples 1 to 5 were evaluated as described below. Table 3 summarizes the results.

### Evaluation of Porous Glass Layered Structure

SEM images (electron micrographs) were taken at a magnification in the range of 10,000 to 150,000 with a scanning electron microscope (FE-SEMS-4800, manufactured by Hitachi, Ltd.) at an accelerating voltage of 5.0 kV. The images were examined for a porous glass layered structure by observing an interface between porous glass layers having different porosities. A sample that included porous glass layers having different porosities was rated as a, and a sample that included no porous glass layers having different porosities was rated as b.

### Study on Effect of Porosity of Porous Glass Layer

With respect to the porosities of the porous glass layers listed in Table 2, a sample that included a porous glass layer having a low porosity adjacent to the substrate was rated as a, and a sample that included a porous glass layer having a high porosity adjacent to the substrate was rated as b. Samples not having the substrate or a plurality of porous glass layers were not evaluated.

### Evaluation of Strain

A strain of a sample was examined on the basis of the warping of the sample on a flat table. A sample having no warp was rated as a, and a sample having a warp was rated as b.

### Evaluation of Strength

10-mm portions on the opposite sides of a sample were fixed. A 100-g weight was placed on the 10 mm×10 mm central area of the sample. The strength of the sample was evaluated by the fracture of the sample. A sample having no fracture was rated as a, and a sample having a fracture was rated as b.

TABLE 3

| | Example | Example | Example | Example | Comparative | Comparative | Comparative | Comparative | Comparative |
|---|---|---|---|---|---|---|---|---|---|
| | 1 | 2 | 3 | 4 | Example 1 | Example 2 | Example 3 | Example 4 | Example 5 |
| Layered | a | a | a | a | a | b | b | a | b |
| structure | | | | | | | | | |
| Porosity of | | | | | | | | | |
| porous glass | a | a | a | a | b | — | — | — | — |
| layer | | | | | | | | | |
| Strain | a | a | a | a | a | b | a | b | a |
| Strength | a | a | a | a | a | b | a | b | a |

### Evaluation of Surface Reflectance

The surface reflectance of each of the samples 1 to 7 was measured with a reflectometer (USPM-RU, manufactured by Olympus Corp.) at a wavelength in the range of 450 to 650 nm at intervals of 1 nm. The maximum reflectance was used as the reflectance of the structure.

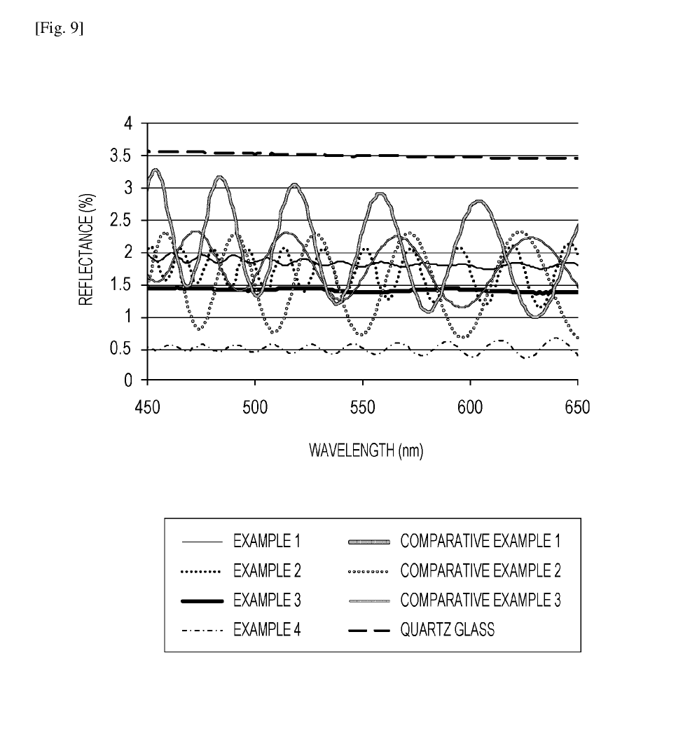

FIG. 9 illustrates the surface reflectance measurements. The reflectance of the quartz substrate was approximately 3.5% at a wavelength in the range of 450 to 650 nm Thus, the samples according to the examples had low reflectance.

The amplitude of ripples was less than 0.5% in the samples according to Examples 1 to 4. Thus, the difference between the maximum reflectance and the minimum reflectance was less than 1%, resulting in low wavelength dependence. The sample 3 according to Example 3, in which the first porous glass layer 21 had a smaller thickness than the second porous glass layer 22, had little wavelength dependence and a substantially constant reflectance at a wavelength in the range of 450 to 650 nm.

In the sample 4 according to Example 4, the first porous glass layer 21 and the second porous glass layer 22 had a low porosity. This structure results in stronger reflected light at the interface between the second porous glass layer 22 and air but weaker reflected light at the interface between the substrate 1 and the second porous glass layer 22 than the samples according to the other examples. It is surmised that reflected light at the interface between the substrate 1 and the second porous glass layer 22 has a great influence on the reflectance of an optical member having the layered structure of the substrate 1 and the porous glass layer 2, and the reflectance of the optical member should be smaller than the samples according to the other examples.

The samples according to Comparative Examples 1 to 3 had a ripple amplitude of 0.5% or more and high wavelength dependence and were therefore somewhat difficult to use as optical members.

In particular, the sample 5 according to Comparative Example 1 included the porous glass layer having a high porosity and a porous glass layer having a low porosity on the substrate in this order. This results in a high reflectance at the interface between the substrate and the porous glass layer and a high ripple amplitude, and the maximum reflectance at a wavelength in the range of 450 to 650 nm was approximately 3.3%.

The sample 6 according to Comparative Example 2 included the single porous glass layer having a uniform porosity on the substrate. This results in a high reflectance at the interface between the substrate and the porous glass layer and a high ripple amplitude, and the maximum reflectance at a wavelength in the range of 450 to 650 nm was approximately 2.3%.

The sample 7 according to Comparative Example 3 had a smaller thickness than the sample 6 according to Comparative Example 2 and a somewhat lower ripple amplitude. However, the ripple amplitude was still 0.5% or more. Thus, it was somewhat difficult to use the sample 7 as an optical member.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-275103, filed Dec. 15, 2011, which is hereby incorporated by reference herein in its entirety.

### REFERENCE SIGNS LIST

1 Substrate
2 Porous glass layer
21 First porous glass layer
22 Second porous glass layer
41 First base glass layer
42 Second base glass layer
51 First phase separation glass layer
52 Second phase separation glass layer

1. An optical member, comprising: a substrate; and a porous glass layer disposed on the substrate,
wherein the porous glass layer includes a first porous glass layer and a second porous glass layer in order on the substrate, the first porous glass layer comprising a region having a uniform porosity, the second porous glass layer comprising a region having a higher uniform porosity than the first porous glass layer.

2. The optical member according to claim 1, wherein the second porous glass layer has a larger average skeleton size than the first porous glass layer.

3. The optical member according to claim 1, wherein the porous glass layer has a thickness of 0.2 micrometers or more and 50.0 micrometers or less.

4. The optical member according to claim 1, wherein the first porous glass layer has a thickness of 0.1 micrometers or more and 2.0 micrometers or less.

5. An image pickup apparatus, comprising: the optical member according to claim 1; and an image pickup element.

6. A method for manufacturing an optical member having a porous glass layer on a substrate, comprising:
forming a phase-separable first base glass layer and a phase-separable second base glass layer on the substrate, the second base glass layer having a different composition from the first base glass layer,
phase-separating the first base glass layer from the second base glass layer to form a first phase separation glass layer and a second phase separation glass layer on the substrate, and
etching the first phase separation glass layer and the second phase separation glass layer to form a porous glass layer on the substrate, the porous glass layer including a first porous glass layer comprising a region having a uniform porosity and a second porous glass layer having a uniform porosity in order on the substrate, the second porous glass layer comprising a region having a higher porosity than the first porous glass layer.

7. The method for manufacturing an optical member according to claim 6, wherein
the forming of a first base glass layer and a second base glass layer includes
forming a first glass powder layer and a second glass powder layer on the substrate, the second glass powder layer having a different composition from the first glass powder layer, and
heating the first glass powder layer and the second glass powder layer to form the first base glass layer and the second base glass layer.

8. The method for manufacturing an optical member according to claim 7, wherein the forming of a first base glass layer and a second base glass layer includes heat treatment at a temperature of at least the higher one out of the glass transition temperature of the first glass powder layer and the glass transition temperature of the second glass powder layer and lower than the higher temperature+500 degrees Celsius.

9. The method for manufacturing an optical member according to claim 6, wherein
the forming of a first base glass layer and a second base glass layer includes
forming a first glass powder layer on the substrate and heating the first glass powder layer to form the first base glass layer, and
forming a second glass powder layer on the first base glass layer, the second glass powder layer having a different composition from the first glass powder layer, and heating the second glass powder layer to form the second base glass layer.

10. The method for manufacturing an optical member according to claim 9, wherein the forming of the second base glass layer on the first base glass layer includes heat treatment at a temperature equal to or higher than the higher one out of the glass transition temperature of the first glass powder layer and the glass transition temperature of the second glass powder layer and lower than the higher temperature+500 degrees Celsius.
